(19) United States
(12) Patent Application Publication
(10) Pub. No.: US 2020/0073174 A1
(43) Pub. Date: Mar. 5, 2020

(54) LIGHTING DEVICE AND DISPLAY DEVICE PROVIDED WITH THE SAME

(71) Applicant: SHARP KABUSHIKI KAISHA, Sakai City (JP)

(72) Inventors: HIROTOSHI YASUNAGA, Sakai City (JP); HISASHI WATANABE, Sakai City (JP); YOUZOU KYOUKANE, Sakai City (JP)

(21) Appl. No.: 16/549,498

(22) Filed: Aug. 23, 2019

Related U.S. Application Data
(60) Provisional application No. 62/724,810, filed on Aug. 30, 2018.

(51) Int. Cl. G02F 1/1335

(52) U.S. Cl. CPC G02F 1/133605; G02F 2201/34; G02F 1/133603

(57) ABSTRACT

A lighting device has a substrate on which a plurality of light emitting elements are arranged side by side, and a reflector configured to diffusely reflect light emitted by the plurality of light emitting elements. The reflector has a predetermined reflector pattern including a light reflection part and a light transmission part. The reflector pattern is formed in the reflector such that the light reflection part overlaps the light emitting elements in front view, where each of the light emitting elements is focused on a center thereof and viewed in front of itself from one side of the substrate on which the light emitting elements are mounted. The reflector is contoured three-dimensionally to include solid portions for covering the light emitting elements one by one in the front view.

### BACKGROUND OF THE INVENTION

### Field of the Invention

The present invention relates to a lighting device such as a backlight unit and a display device provided with the same.

### Description of the Related Art

A direct-lit lighting device is a type of lighting devices such as a backlight unit, and is composed of a display element, a substrate disposed behind the display element, and a plurality of light emitting elements such as light emitting diodes (LED) arranged side by side on the substrate. The display element is illuminated entirely and uniformly from behind by the light emitting element. In some cases, the direct-lit lighting device controls the amount of light emitted from the plurality of light emitting elements individually or zone by zone (known as local dimming control). Local dimming control is a lighting technology capable of area driving, and can realize high contrast and low power consumption in the display device (display).

In many of the lighting devices that provide local dimming control, the light emitting elements are provided in an active area, as typically represented by direct-lit lighting devices. A direct-lit backlight unit is one of the mainstream devices. In most cases, the light emitting elements used in direct-lit lighting devices are top-view light emitting elements (light emitting elements whose light emission surfaces are on the top side and whose electrode surfaces on the bottom side). The top-view light emitting elements are in common use.

However, conventional direct-lit lighting devices have some defects, as described below by way of a backlight unit.

FIG. 16 is a partial schematic sectional view of an example of a conventional backlight unit 6 without a reflector. FIG. 17 is a partial schematic sectional view of an example of a conventional backlight unit 6 provided with a reflector 3. Each of the backlight units 6 shown in FIGS. 16 and 17 is also equipped with an optical member group 4 and a reflection sheet 5. The optical member group 4 includes a prism sheet 4a and a diffuser plate 4b. The prism sheet 4a is composed of a first lens sheet 4a1 and a second lens sheet 4a2. FIG. 18 is a schematic plan view of the backlight unit 6 shown in FIG. 17, with the optical member group 4 removed. Dashed lines in FIG. 18 define local dimming division areas AR. FIG. 19 is a schematic plan view of a zone corresponding to an LED 1, as an example of a reflector pattern 3a of the reflector 3, in the backlight unit 6 shown in FIG. 17.

In the backlight unit 6 (a lighting device) having the structure shown in FIG. 16, intense light L emitted from light emitting surfaces 1a of LEDs 1 . . . 1 is directly visible without scatter reflection, and creates intense emission points (hot spots). As a result, the LEDs 1 are likely to be recognized as emission points (hot spots) and render the luminance of the backlight unit 6 severely uneven. Further in this backlight unit, the amount of light emitted from the LEDs 1 is less at locations distant from just above the LEDs 1 (in other words, locations between the LEDs 1, particularly around the midpoints between the LEDs 1) than at locations just above the LEDs 1. For the normal top-view LEDs 1, the amount of emitted light beam is maximum at and around the front, and the amount of emitted light beam decreases as the polar angle increases. Accordingly, the luminance is low around the midpoints between the LEDs 1, which results in uneven luminance.

A simple and effective manner for alleviating uneven luminance is to increase the spatial distance d from the LEDs 1 to the optical member group 4. In the direct-lit backlight unit 6 having a certain LED pitch, a greater spatial distance d between the LEDs 1 and the optical member group 4 allows light to spread more uniformly inside the backlight unit 6. On the other hand, as a commercial product, the backlight unit 6 is preferably thinner so as to reduce the thickness and the weight of the display device (display). For these reasons, it has been desired to solve uneven luminance without excessively increasing the thickness of the backlight unit 6.

As a method for alleviating uneven luminance, the backlight unit 6 may be provided with a patterned reflector 3 just above the LEDs 1 with a gap, as shown in FIGS. 17 and 19 (see, for example, JP 2010-185906 A, and JP 2717650 B2). This method can alleviate the uneven luminance so effectively as to realize a thinner direct-lit backlight unit 6. The pattern of the reflector 3 is designed to give a high block factor at locations just above the LEDs 1 and their vicinity and to give a low block factor at locations distant from just above the LEDs 1 in the planar direction of the LED board 2. Such a reflector can alleviate uneven luminance in the backlight unit 6 and equalize the in-plane luminance distribution. Specifically, light L is diffusely reflected by the reflector 3 and re-used on the reflection sheet 5 below. Hence, by increasing the block area ratio of the reflector 3 at a high-luminance part and decreasing the block area ratio of the reflector 3 at a low-luminance part, it is possible to equalize the luminance distribution in the backlight unit 6.

Use of the reflector 3 involves a problem with the viewing angle. The reflector 3 can be positioned just above the LEDs 1, with a certain distance between the reflector 3 and the LEDs 1, such that the LEDs 1 are invisible to a viewer in front of the backlight unit 6. Due to this distance, however, the positional relationship between the LEDs 1 and the patterned reflector 3 changes when a viewer is at an angle on the front side. When viewed at an angle, the LEDs 1 are no longer covered by the reflector 3, and light L emitted by the LEDs 1 is visible without being blocked by the reflector 3. Eventually, when a viewer is at an angle on the front side of the backlight unit 6, uneven luminance is noticeable across the emission points (hot spots). Namely, even if the backlight unit 6 is designed to provide uniform luminance for a viewer in front, luminance is still uneven for a viewer at an angle on the front side.

FIG. 20 is a schematic sectional view of an example of the backlight unit 6 shown in FIG. 17, in which the reflector 3 is arranged to shield the LEDs 1 when viewed not only in front but also at an angle. Signs φ, φ′ in FIG. 20 indicate viewing angles.

In FIG. 20, the reflector 3 is arranged to shield the LEDs 1 in the backlight unit 6 shown in FIG. 17 when viewed not only in front but also at an angle. A covered zone α, where a corresponding LED 1 is covered by the reflector 3, extends in the planar direction of the LED board 2. Since the patterned reflector 3 requires a large block area, a peripheral part γ distant from just above the LED 1 in the planar direction of the LED board 2 is dark and causes uneven luminance when a viewer is in front. This phenomenon is more and more noticeable if a spatial distance e between the LEDs 1 and the reflector 3 is greater.

In this regard, JP 5550505 B2 discloses a lighting device that has a planar radiation surface, a light source substrate on which at least one light source is mounted face to face with the radiation surface, and a sheet-like optical control member disposed between the radiation surface and the light source. In the optical control member, at least one of the optical characteristics including transmission, refraction, scattering and reflection is different in every zone, and the optical characteristics distribution is determined by the position relative to one of the light sources. The optical control member is controlled by at least one of a reflective film having a reflectance distribution, a reflective film having an aperture ratio distribution, and lenses. The optical control member has a group of patterns in a micro cycle, with a distance between the optical control member and the radiation surface being greater than the cycle in the group of patterns. The optical control member is formed in a dome-shape covering the light source over the light source substrate, and each zone of the optical control member has a transmittance distribution in accordance with an incident light distribution from the light source.

Nevertheless, the lighting device disclosed in JP 5550505 B2 pays no attention to the situation where light emitted by the light emitting element is visible without being shielded by the reflector when a viewer is at an angle on the front side. Hence, when a viewer is at an angle, emission points (hot spots) are noticeable and result in uneven luminance.

In consideration of the aforementioned problem, the present invention aims to provide a lighting device that can prevent uneven luminance not only when a viewer is in front but also when a viewer is at an angle, and also to provide a display device provided with this lighting device.

### SUMMARY OF THE INVENTION

The knowledge of the inventors is directed to a lighting device that has a substrate on which a plurality of light emitting elements are arranged side by side, and a reflector configured to diffusely reflect light emitted by the plurality of light emitting elements. In this lighting device, the reflector for shielding the light emitting elements is contoured three-dimensionally to include solid portions. As a result, the lighting device can reduce the shield area as viewed in front, while increasing the viewing angle range in which the light emitting elements are shielded.

(1) The present invention is based on the above knowledge and made in order to solve the above-mentioned problems. A lighting device according to an aspect of the present invention has a substrate on which a plurality of light emitting elements are arranged side by side, and a reflector configured to diffusely reflect light emitted by the plurality of light emitting elements. The reflector has a predetermined reflector pattern including a light reflection part and a light transmission part. The reflector pattern is formed in the reflector such that the light reflection part overlaps the light emitting elements in front view, where each of the light emitting elements is focused on a center thereof and viewed in front of itself from one side of the substrate on which the light emitting elements are mounted. The reflector is contoured three-dimensionally to include solid portions for covering the light emitting elements one by one in the front view. A display device according to an aspect of the present invention is provided with the lighting device according to an aspect of the present invention as described above.

(2) The lighting device according to an embodiment of the present invention is based on the configuration of (1) above, and further includes an optical member group provided on one side of the reflector that is not a substrate-facing side of the reflector. The reflector serves also as a support member for holding up the optical member group.

(3) The lighting device according to an embodiment of the present invention is based on the configuration of (1) or (2) above. Further, each of the solid portions of the reflector has a semi-spherical or semi-elliptical shape.

(4) The lighting device according to an embodiment of the present invention is based on the configuration of (1) or (2) above. Further, each of the solid portions of the reflector has a cone-like or frustum-like shape.

(5) The lighting device according to an embodiment of the present invention is based on the configuration of any one of (1) to (4) above. Further, each of the solid portions of the reflector has a peripheral end that is an end closer to the substrate, and the light transmission part includes a plurality of light transmission parts formed circumferentially and entirely along the peripheral end of each solid portion.

(6) The lighting device according to an embodiment of the present invention is based on the configuration of any one of (1) to (5) above, and further includes a positioning unit configured to position the reflector on the substrate.

(7) The lighting device according to an embodiment of the present invention is based on the configuration of (6) above. Further, the positioning unit includes a protrusion that is directly or indirectly fixed on the substrate, and the reflector is engaged with the protrusion.

(8) The lighting device according to an embodiment of the present invention is based on the configuration of (7) above. Further, the reflector has an aperture to be engaged with the protrusion.

(9) The lighting device according to an embodiment of the present invention is based on the configuration of (7) above. Further, the reflector has a recess to be engaged with the protrusion.

(10) A display device in an embodiment of the present invention includes the configuration of any one of (1) to (9).

The present invention can prevent uneven luminance not only when a viewer is in front but also when a viewer is at an angle.

### BRIEF DESCRIPTION OF THE DRAWINGS

FIG. 1 is a partial schematic sectional view of a liquid crystal display device provided with an example of a backlight unit according to First Embodiment.

FIG. 2 is a schematic plan view of the backlight unit shown in FIG. 1, with an optical member group removed.

FIG. 3 is a schematic plan view of a zone corresponding to an LED, as an example of a reflector pattern of a reflector, in the backlight unit shown in FIG. 1.

FIG. 4 is a schematic sectional view that shows viewing angles in the backlight unit shown in FIG. 1.

FIG. 5 is a partial schematic sectional view of an example of the backlight unit according to Second Embodiment.

FIG. 6 is a partial schematic plan view of an example of a reflector pattern in the reflector shown in FIG. 5.

FIG. 7 is a schematic sectional view showing another example of the backlight unit according to First Embodiment.

FIG. 8 is a schematic sectional view showing yet another example of the backlight unit according to First Embodiment.

FIG. 9 is a schematic sectional view showing another example of the backlight unit according to Second Embodiment.

FIG. 10 is a schematic sectional view showing yet another example of the backlight unit according to Second Embodiment.

FIG. 11 is an explanatory drawing for giving more specific numerical description of the example shown in FIG. 7.

FIG. 12 is an explanatory drawing for giving more specific numerical description of the example shown in FIG. 9.

FIG. 13 is an explanatory drawing for giving more specific numerical description of the example shown in FIG. 10.

FIG. 14 is a partial schematic sectional view of the backlight unit according to Third Embodiment.

FIG. 15 is a partial schematic sectional view of the backlight unit according to Fourth Embodiment.

FIG. 16 is a partial schematic sectional view of an example of a conventional backlight unit without a reflector.

FIG. 17 is a partial schematic sectional view of an example of a conventional backlight unit provided with a reflector.

FIG. 18 is a schematic plan view of the backlight unit shown in FIG. 17, with an optical member group removed.

FIG. 19 is a schematic plan view of a zone corresponding to an LED, as an example of a reflector pattern of the reflector, in the backlight unit shown in FIG. 17.

FIG. 20 is a schematic sectional view of an example of the backlight unit shown in FIG. 17, in which a reflector is arranged to shield LEDs when viewed not only in front but also at an angle.

### DESCRIPTION OF THE PREFERRED EMBODIMENTS

Hereinafter, embodiments of the present invention are described with reference to the drawings. In the following description, identical components having the same name and functions are respectively identified by the same reference signs, and thereby description of such components will not be repeated

### First Embodiment

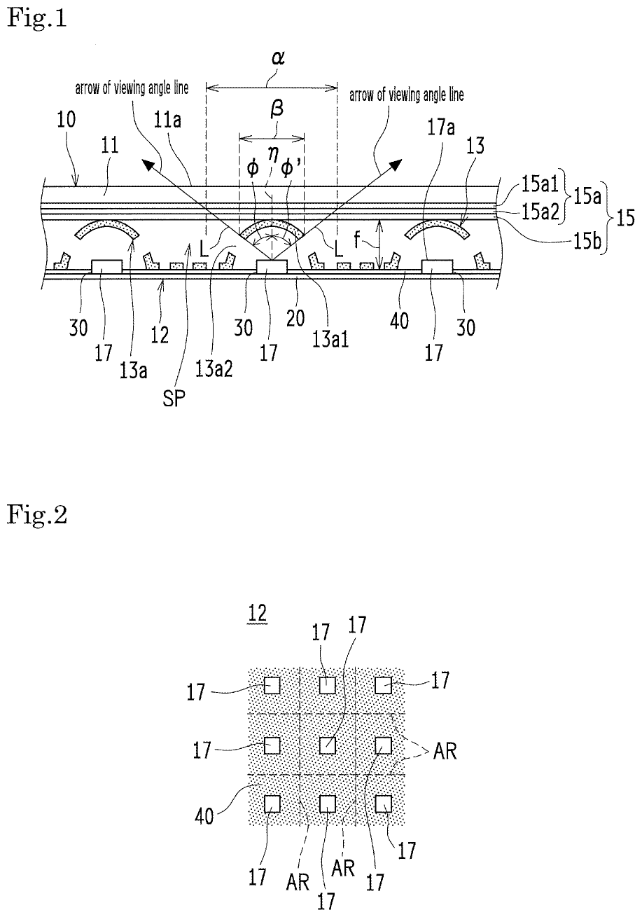

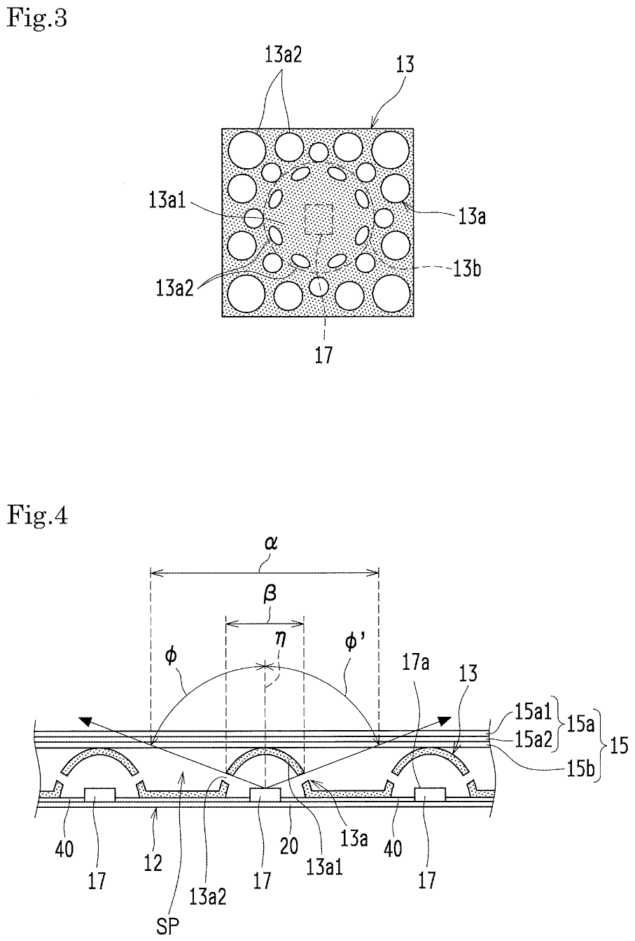

FIG. 1 is a partial schematic sectional view of a liquid crystal display device 10 provided with an example of a backlight unit 12 according to First Embodiment. Signs φ, φ′ in FIG. 1 indicate viewing angles. FIG. 2 is a schematic plan view of the backlight unit 12 shown in FIG. 1, with an optical member group 15 removed. Dashed lines in FIG. 2 define local dimming division areas AR. FIG. 3 is a schematic plan view of a zone corresponding to an LED 17, as an example of a reflector pattern 13a of a reflector 13, in the backlight unit 12 shown in FIG. 1.

As shown in FIG. 1, the liquid crystal display device 10 (an example of the display device) is provided with a liquid crystal panel 11 (an example of the display element) and a backlight unit 12 (an example of the lighting device) configured to illuminate the liquid crystal panel 11 from behind. The shape of the liquid crystal display device 10 is not particularly limited, and may be rectangular or square.

The liquid crystal panel 11, whose details are omitted in the drawings, is composed of a pair of glass substrates bonded together with a predetermined gap, and a liquid crystal sandwiched between the glass substrates.

The backlight unit 12 is a direct-lit backlight unit and faces a surface of the liquid crystal panel 11 opposite to a display surface 11a thereof. The backlight unit 12 includes an optical member group 15 and an LED board 20 (an example of the substrate). The optical member group 15 includes a prism sheet 15a and a diffuser plate 15b. The optical member group 15 is disposed between the liquid crystal panel 11 and the reflector 13, on a surface of the reflector 13 not facing the LED board 20. The prism sheet 15a is a stack of a plurality of optical sheets, and serves to turn the light transmitted through the diffuser plate 15b into planar light. The prism sheet 15a in this example is made of a first lens sheet 15a1 and a second lens sheet 15a2. The optical member group 15 may further include, for example, a brightness enhancement film. The diffuser plate 15b is made of a plate-like synthetic resin member in which light scattering particles are dispersed, and serves to diffuse light. The backlight unit 12 is further provided with a reflection sheet 40. The reflection sheet 40 has a white reflection surface that has a remarkable light-reflecting property. The reflection sheet 40 is provided on the LED board 20 (specifically, a surface of the LED board 20 on which the LEDs 17 are mounted). The reflection sheet 40 has a plurality of apertures 30-30. The LEDs 17-17 are aligned one by one with the apertures 30-30 in the reflection sheet 40, and are exposed (inserted) through the apertures 30-30. The apertures 30-30 are designed to the shape of the LEDs 17-17, and may have the totally or substantially same shape as the LEDs 17-17. All of the apertures 30-30 have an identical shape. The reflection sheet 40 is fixedly bonded on the LED board 20 by double-sided adhesive sheets (not shown) at a plurality of positions.

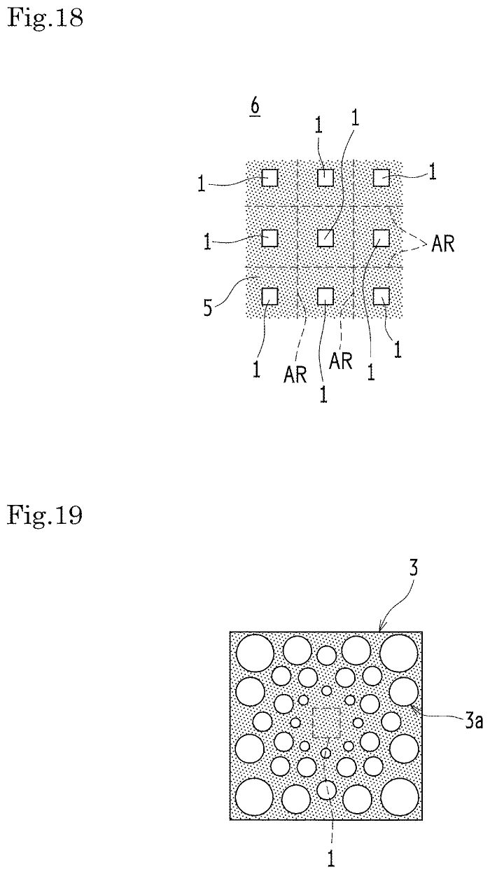

In the present embodiment, the light sources for the backlight unit 12 are light emitting diodes 17 (an example of the light emitting elements, hereinafter mentioned as “LEDs 17”). Preferably, the LEDs 17 are white LEDs that emit white light. In the active area, each of the local dimming division areas AR (see FIG. 18) contains at least one LED 17.

The LED board 20 is coated with a white resist material (specifically, white ink). On the LED board 20 coated with the white resist material, LEDs 17-17 are arranged side by side in a matrix at a predetermined fixed pitch (see FIG. 2). The LEDs 17-17 emit light L from the light emitting surfaces 17a that are not the surfaces facing the LED board 20. In this example, the LEDs 17-17 are top-emitting chip LEDs mounted on the LED board 20 such as a rigid substrate (for example, a rigid substrate made of a metallic material like aluminum) or a flexible printed board (for example, a flexible substrate made of a resin material like polyimide). The LED board 20 is electrically connected to a power source unit (not shown) controlled by a power source control unit (not shown) via a connector (not shown). A voltage is applied to the LED board 20 from the power source unit and lights up the LEDs 17-17. The power source control unit provides local dimming control of the power source unit. The thus configured backlight unit 12 can illuminate the liquid crystal panel 11 at high luminance and high contrast. All of the LEDs 17-17 have an identical shape (identical specifications). Typically, the formation of the LEDs 17-17 (the shape of the light emitting surfaces 17a) may be rectangular, square, elliptic, or circular in plan view.

The diffuser plate 15b is opposed to a surface of the LED board 20 and the LEDs 17 mounted thereon, and is spaced from the surface of the LED board 20 by a predetermined distance f. Materials for the diffuser plate 15b include heat-resistant resin materials such as polycarbonate resins and acrylic resins. In this example, the diffuser plate 15b is made of a polycarbonate resin.

The backlight unit 12 is provided with a reflector 13 by which light L emitted by the plurality of LEDs 17-17 is diffusely reflected. The reflector 13 has a predetermined reflector pattern 13a. The reflector pattern 13a is composed of a light reflection part 13a1 and light transmission parts 13a2. The reflector pattern 13a is formed in the reflector 13 such that the light reflection part 13a1 overlaps the LEDs 17-17 when viewed in front of each LED 17 from the LED side of the LED board 20. The reflector 13 is contoured three-dimensionally to include solid portions for covering the LEDs 17-17 in front view.

According to the present embodiment, the reflector 13 having the reflector pattern 13a is not a flat member provided along the LED board 20, but is contoured three-dimensionally to include solid portions for covering the LEDs 17-17 in front view. When a viewer is in front, the light reflection part 13a1 covers and shields the LEDs 17. When a viewer is at an angle on the front side, the light reflection part 13a1 still shields the LEDs 17, and light L emitted by the LEDs 17 is not visible through the light transmission parts 3a2.

The present embodiment can thus prevent uneven luminance not only when a viewer is in front but also when a viewer is at an angle.

In this description, the light reflection part 13a1 that constitutes the reflector pattern 13a is a diffusely reflecting part (e.g., a white resin part, a white printed part, or the like) and/or a specularly reflecting part (e.g., a dielectric multilayer, a silver sheet, or the like), each of which reflects light L emitted by the LEDs 17 at an optical reflectance of 30% or higher. The light reflection part 13a1 may also transmit light L emitted by the LEDs 17. The light transmission parts 13a2 that constitute the reflector pattern 13a transmit light L emitted by the LEDs 17 at a light transmittance of 70% or higher (specifically, through holes, transparent parts, and/or semi-transparent parts). The light transmission parts 13a2 may also reflect light L emitted by the light emitting elements.

FIG. 4 is a schematic sectional view that shows viewing angles φ, φ′ in the backlight unit 12 shown in FIG. 1. Within the viewing angles φ, φ′, a displayed image is visually recognizable without problem when the liquid crystal display device 10 (display) is viewed at an angle.

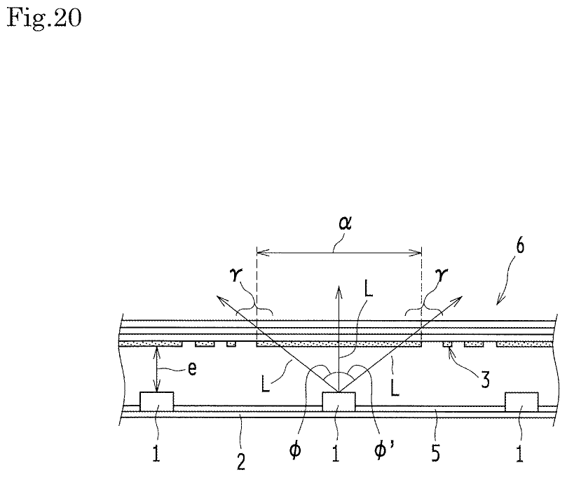

Turning back to FIG. 20, the conventional backlight unit 6 uses the flat reflector 3. The pattern of the flat reflector 3 is designed such that the reflector 3 can hide each LED 1 when a viewer is in front within the viewing angle range of the equal viewing angles φ, φ′. To hide an LED 1, the reflector 3 needs to cover the covered zone α. On the other hand, the backlight unit 12 as shown in FIGS. 1 and 4 uses the solid (three-dimensional) reflector 13. To hide an LED 17, the light reflection part 3a1 only needs to cover the covered zone ß within the viewing angle range of the equal viewing angles φ, φ′. This is also applicable to the backlight unit 12 according to Second Embodiment to be described below.

It should be understood that the present invention is not directed to a technology for shielding a light emitting element in a specific viewing angle range. Actually, the present invention provides a technology for reducing the shield area for a certain viewing angle range in front view, in other words, a technology for increasing the viewing angle range to be shielded while the shield area in front view is unchanged. Hence, the viewing angles φ, φ′ are not limited or prescribed to a particular range, but can be decided in accordance with the desired viewing angle range to be shielded. A designer may determine the range of the viewing angles φ, φ′ to meet required specifications of the models.

The reflector 13 is provided with the reflector pattern 13a for eliminating uneven luminance, and includes portions that overlap the plurality of LEDs. The overlapping portions are contoured at their centers and peripheries to cover (enclose) the plurality of LEDs 17-17 one by one in plan view.

The backlight unit 12 may be equipped with suitable members as required. A reflective layer such as a multi-layer reflection film (ESR: Enhanced Specular Reflector) or a white resin material (e.g., white PET: polyethylene terephthalate) may be provided just above the display surface of the LED board 20. An optical sheet such as a brightness enhancement film (BEF), a scattering material, a reflective polarizing film (DBEF: Dual Brightness Enhancement Film), or a turning lens may be provided above the display surface of the LED board 20.

The ESR is a reflection sheet composed of a dielectric multilayer, like an ESR manufactured by Sumitomo 3M Limited, but is not limited to the product of Sumitomo 3M Limited. The BEF is an optical sheet shaped like a BEF manufactured by Sumitomo 3M Limited, but is not limited to the product of Sumitomo 3M Limited. For example, two BEFs are stacked with their prism direction orthogonal to each other, but a single BEF may be employed in some cases. The scattering material can be chosen from various materials, and may be a thin diffusion sheet having a thickness of about 30 μm or a diffuser plate having a thickness of 3 mm. The DBEF is an optical sheet having polarized reflection characteristics, like a DBEF manufactured by Sumitomo 3M Limited, but is not limited to the product of Sumitomo 3M Limited.

In order to fix the constitutive members and to prevent leakage of light, a frame and/or a bezel may be provided to cover at least one side along the outer periphery of the main body of the backlight unit. The outer peripheral frame is made of, for example, a resin material such as polycarbonate. The backlight unit in the present embodiment is equipped with a frame only (not shown). A preferable frame is made of a resin material having a highest possible reflectance (e.g., white polycarbonate). The bezel may be made of, for example, a rust-proof material such as stainless steel or aluminum. In addition, the outer peripheral frame (or bezel) may be bonded to the liquid crystal panel 11 and the backlight unit 12 by double-sided adhesive sheets (pieces of a double-faced adhesive tape) at portions facing the liquid crystal panel 11 and the backlight unit 12 and at any optional positions. Preferably, in the double-sided adhesive sheets attached to the outer peripheral frame (or bezel) at portions facing the liquid crystal panel 11 and the backlight unit 12, the surface attached to the backlight unit 12 has a higher lightness (e.g., white), and the surface attached to the liquid crystal panel 11 has a lower lightness (black).

A space SP is given between the LEDs 17 and the optical member group 15. The solid reflector 13 is accommodated in the space SP. The reflector pattern 13a formed in the reflector 13 is composed of the light reflection part 13a1 and the light transmission parts 13a2.

In the reflector 13, the preferable specific shape of the solid portions is, for example, semi-spherical or semi-elliptical, with the centers of the solid portions being aligned with the centers of the light emitting surfaces 17a of the LEDs 17-17 in front view. This specific shape facilitates prevention of uneven luminance not only when a viewer is in front but also when a viewer is at an angle.

The reflector 13 may be, for example, a reflection sheet through which patterned light transmission parts 13a2 (specifically, through holes) are formed or a transparent sheet on which patterned light transmission parts 13a2 are printed with a white coating material. In the reflection sheet through which patterned through holes are formed, the sheet portion except the through holes serves as the light reflection part 13a1, and the through holes serve as the light transmission parts 13a2. The material for the reflection sheet may be, for example, a white resin sheet (specifically, a PET sheet, etc.). In the transparent sheet on which a pattern is printed with a white coating material, the portion of the white coating serves as the light reflection part 13a1, and the non-printed portions except the white coating portion serve as the light transmission parts 13a2. The transparent sheet may be, for example, a transparent or semi-transparent resin sheet (specifically, a transparent acrylic sheet, etc.) or a semi-transparent resin sheet having a light-diffusing function (specifically, a diffusion sheet, etc.). The pattern may be printed on whichever of a light emitting surface or a light entering surface of the printable sheet. The reflector pattern 13a of the reflector 13 may be formed such that the light reflection part 13a1 occupies a smaller area in a location distant from a location just above each LED 17 (i.e., each light source) than in the location just above each LED 17. This arrangement equalizes in-plane distribution of luminance. Namely, the reflector pattern 13a can change the optical reflectance in accordance with the luminance distribution of each LED 17 (in accordance with the distance from each light source) so as to equalize light L emitted by each LED 17. The reflector pattern 13a is regularly arranged above each LED 17. By this reflector pattern 13a, light L emitted from each LED 17 is diminished just above the LED 17, reflected and diffused repeatedly, and can be equalized.

In the reflection sheet that includes the light transmission parts 13a2 (specifically, through holes) as shown in FIGS. 1 to 3, the reflector pattern 13a for a single dimming area is provided repeatedly in every area. In this case, the reflector pattern 13a may not necessarily be identical in all areas but may be different in every area.

To create the space SP in the backlight unit 12, the optical member group 15 needs to be held up by a certain structure at more than one position in the plane. Usually, the backlight unit 12 needs the space SP for the reflector 13 between the LEDs 17 and the reflector 13. For example, structural members (e.g., resin columns) are provided at two or more positions in the plane so as to hold up the reflector 13 and the optical member group 15 (e.g., an optical sheet) on top of the reflector 13. Such structural members, however, obstruct light and often cause uneven luminance.

In this embodiment, the reflector 13 itself is contoured three-dimensionally, and serves also as a support member for holding up the optical member group 15. This reflector 13 can keep the space SP between the LEDs 17 and the reflector 13. Since the reflector 13 serves also as the support member for holding up the optical member group 15, the present embodiment can dispense with optically obstructive, columnar structural members, and can thereby prevent possible uneven luminance due to the additional support members for holding up the optical member group 15. Further, use of a fewer components can reduce the cost and weight.

The optical member group 15 is composed of, for example, at least two of the prism sheet 15a, the BEF, the scattering material (the diffusion sheet or the diffuser plate 15b), the DBEF, and the turning lens.

In the reflector 13 according to this configuration, the light transmission parts 13a2 (specifically, through holes) are essential at the protruding contoured portions, but are optional at the other portion (the flat non-contoured portion) on the LED board 20 or the reflection sheet 40 laid on the LED board 20. For example, if the reflection sheet 40 laid on the LED board 20 is a diffusion member made of white PET or the like and the reflector 13 is made of a similar material, the light transmission parts 13a2 formed in the non-contoured portion are less useful because of the similar underlying material. Thus, depending on the configuration of the reflector 13, omission of the light transmission parts 13a2 in the non-contoured portion may contribute to cost reduction or improvement in rigidity of the reflector 13. On the other hand, if the reflection sheet 40 laid on the LED board 20 has a higher optical reflectance than the reflector 13 (for example, the reflection sheet 40 made of an ESR) and the reflector 13 has a lower optical reflectance than the reflection sheet 40 (for example, the reflector 13 made of a white diffuse reflector), the presence of the light transmission parts 13a2 in the non-contoured portion facilitates alleviation of uneven luminance and enhancement of luminance.

In the backlight unit 12 according to the present embodiment, each of the solid portions of the reflector 13 has a peripheral end that is an end closer to the LED board 20, and the reflector 13 includes a plurality of light transmission parts 13a2 formed circumferentially and entirely along the peripheral end of each solid portion 13b, as shown in FIG. 3. This arrangement can reliably prevent uneven luminance not only when a viewer is in front but also when a viewer is at an angle. This is also applicable to the backlight unit 12 according to Second Embodiment to be described below.

### Second Embodiment

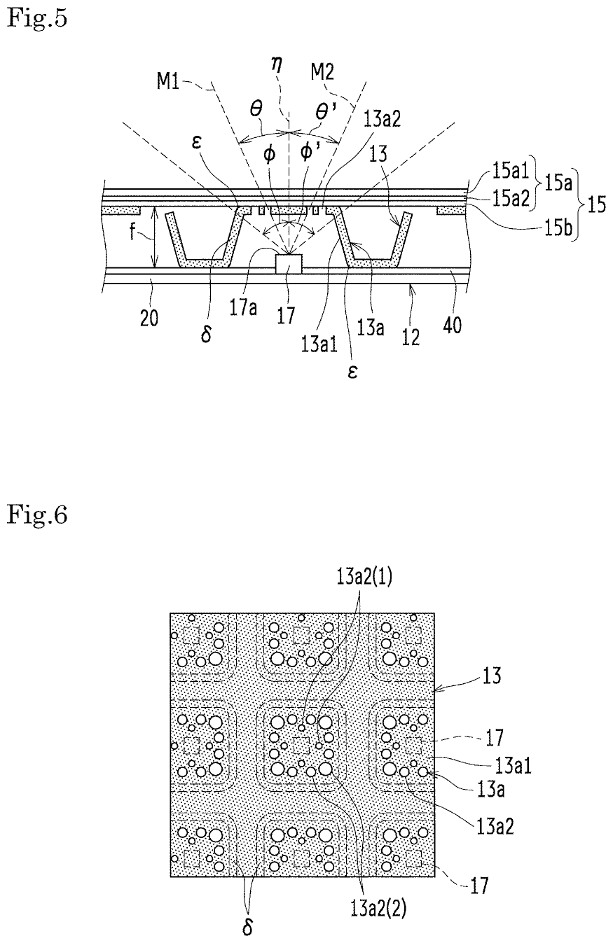

FIG. 5 is a partial schematic sectional view of an example of the backlight unit 12 according to Second Embodiment. FIG. 6 is a partial schematic plan view of an example of the reflector pattern 13a in the reflector 13 shown in FIG. 5.

The backlight unit 12 according to Second Embodiment is substantially identical to the backlight unit 12 according to First Embodiment, except that the solid portions in the reflector 13 have a frustum-like shape.

To be specific, the backlight units 12 according to First and Second Embodiments are basically identical but are different in the following respect. In Second Embodiment, the reflector 13 is bent such that a side surface δ in each solid portion is nearly vertical to the substrate surface of the LED board 20 and such that the other surface in each solid portion is parallel or substantially parallel to the substrate surface of the LED board 20.

Each solid portion in the reflector 13 has, ideally but not necessarily, a semi-spherical shape whose center is aligned with the center of the light emitting surface 17a of the corresponding LED 17. The solid portions may have any shape that three-dimensionally encloses the LEDs 17. For example, the solid portions in the reflector 13 may have a conic shape or a frustum-like shape. The resulting reflector 13 enables manufacture of the backlight unit 12 that can prevent uneven luminance at a wide viewing angle.

Examples of the frustum-like shape include a conical frustum, a triangular frustum, a square frustum, and other polygonal frustums. For example, in pyramidal frustums, surfaces other than the top surface and the bottom surface have an identical or substantially identical shape. Such a shape can improve the strength for holding up the optical member group 15. Examples of the conic shape include a cone, a triangular pyramid, a square pyramid, and other polygonal pyramids. For example, in pyramids, surfaces other than the bottom surface have an identical or substantially identical shape. Such a shape can improve the strength for holding up the optical member group 15.

In the backlight unit 12 according to Second Embodiment, as shown in FIG. 5, each solid portion in the reflector 13 has a frustum shape whose center is aligned in front view with the center of the light emitting surface 17a of the corresponding one of the LEDs 17-17.

In this embodiment, the side surface δ of the reflector 13 is configured to overlap the corresponding LED 17 at oblique viewing angles φ, φ′, and is nearly vertical to the substrate surface of the LED board 20. If a large block area is necessary for the oblique viewing angles φ, φ′, this arrangement can effectively decrease the block area as viewed by a viewer in front. Second Embodiment can decrease the block area for a viewer in front more effectively than First Embodiment. Thus, this arrangement can reduce dark zones for a viewer in front, and can thereby prevent uneven luminance.

The shape of the reflector 13 in Second Embodiment is more robust than that of the reflector 13 in First Embodiment. For example, depending on its shape, the reflector 13 may not be able to hold up the optical member group 15, and may yield slightly and change the distance f. As an additional advantage, Second Embodiment is unlikely to cause such a problem.

However, due to the greater flat surface, Second Embodiment may be sometimes inferior to First Embodiment in shielding the LED 17 for a viewer at an angle on the front side.

In this regard, the backlight unit 12 according to Second Embodiment is further described with reference to FIG. 5. A first imaginary straight line M1 passes through a first end of the light reflection part 13a1 that overlaps the corresponding LED 17 in front view and through the center of the light emitting surface 17a of the LED 17 covered by the light reflection part 13a1. A second imaginary straight line M2 passes through a second end of the reflection part 13a1 opposite to its first end and through the center of the light emitting surface 17a of the LED 17. The perpendicular line η is perpendicular to the light emitting surface 17a. The angles θ, θ′ are angles between the first imaginary straight line M1 and the perpendicular line η and between the second imaginary straight line M2 and the perpendicular line η, respectively. In this embodiment, the angles θ, θ′ are smaller than the predetermined viewing angles φ, φ′. For easier achievement of the effect of the present embodiment, the angles θ, θ′ are ideally greater than the viewing angles φ, φ′. If the angles θ, θ′ are smaller than the viewing angles φ, φ′, the effect of the present embodiment is less expected in the viewing angle range over the angles θ, θ′ up to the viewing angles φ, φ′. In this viewing angle range, the LED 17 cannot be shielded by the reflector 13 when viewed at an angle. However, if the flat portion of the reflector 13 in contact with the optical member group 15 is completely blocked, the shielded portion receives a reduced amount of scattered light from the peripheral part and gets darker than the peripheral part. In order to prevent uneven luminance, it is preferable to form the light transmission parts 13a2 (holes) within the range of the viewing angles φ, φ′, as shown in FIG. 5. Further as shown in FIG. 6, the light transmission parts 13a2(1) are formed at the inner periphery of the light reflection part 13a1 closest to the overlapping the LED 17 in front view, and the light transmission parts 13a2(2) are formed at the outer periphery of the light reflection part 13a1. The area of the light transmission parts 13a2(1) is smaller than that of the light transmission parts 13a2(2), so that each LED 17 can be shielded more easily when a viewer is at an angle on the front side.

According to Second Embodiment, the reflector 13 is arranged such that the angles θ, θ′ are smaller than the viewing angles φ, φ′ and such that the area of the light transmission parts 13a2(1) is smaller than that of the light transmission parts 13a2(2). These arrangements are also applicable to the reflector 13 in First Embodiment.

In the example shown in FIG. 5, the light transmission parts 13a2 are not formed in the side surface δ and the bend ε of the reflector 13. However, the light transmission parts 13a2 may be formed in the side surface δ and/or the bend ε.

### Notes on First Embodiment and Second Embodiment

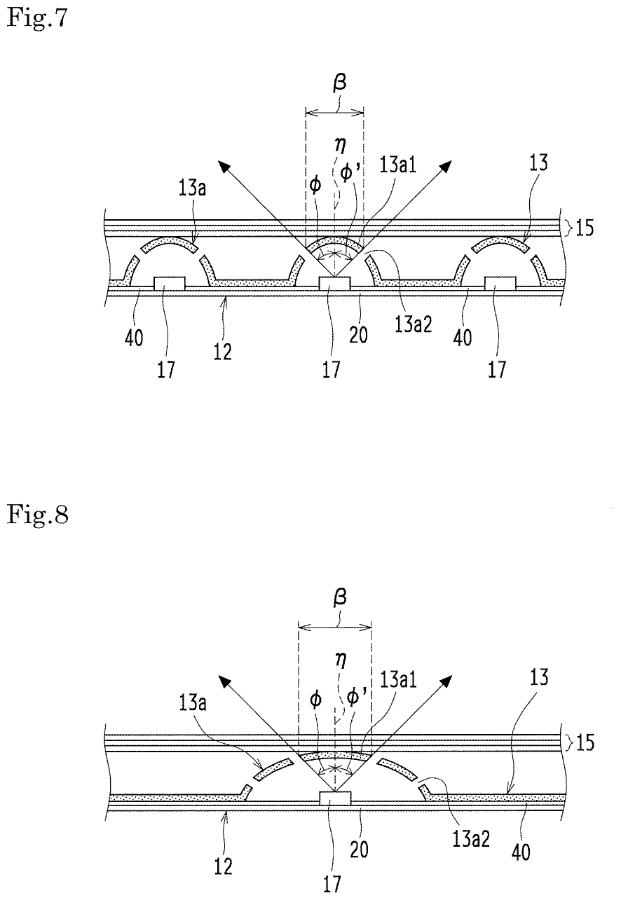

FIG. 7 is a schematic sectional view showing another example of the backlight unit 12 according to First Embodiment. For example, to prevent uneven luminance in the backlight unit 12 at the viewing angles φ, φ′ of 45° or less, the reflector pattern 13a is designed to make the LEDs 17 directly invisible at the viewing angles φ, φ′ of 45° or less. Specifically, in the case where the range of viewing angle lines is equal to the covered zone ß, the light the transmission parts 13a2 (holes) are not provided in the reflector pattern 13a within the range of viewing angle lines (the covered zone ß) drawn from the center of the light emitting surface 17a (the emission point) of each LED 17 at the viewing angles φ, φ′ of 45°. Referring to the reflector pattern 13a in FIG. 7, no light transmission part 13a2 is provided in the reflector pattern 13a within the range of viewing angle lines (the covered zone ß). FIG. 7 is a sectional view of the backlight unit 12 taken in one direction. Actually, the reflector pattern 13a is designed to have no light transmission part 13a2 within the range of viewing angle lines, in every direction in the plane. In other words, the reflector pattern 13a includes no light transmission part 13a2 within the inverted cone-shaped range defined by the viewing angle lines. In this context, the range of viewing angle lines means the distance between the lines that are perpendicular to the light emitting surface 17a and that pass through the intersections of the viewing angle lines and the ends of the light reflection part 13a1.

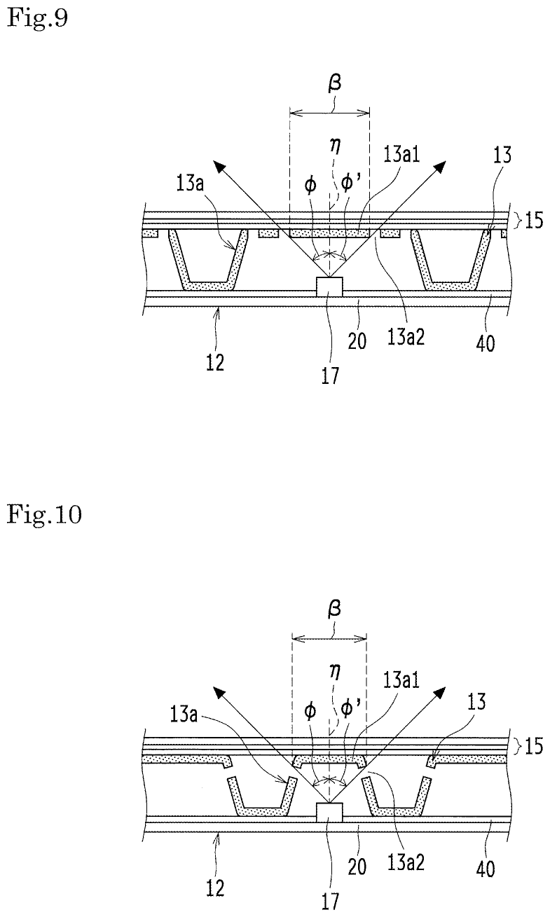

Whatever the shape of the solid portions in the reflector pattern 13a, the light transmission parts 13a2 in the reflector pattern 13a are unnecessary, as described above, within the range of viewing angle lines (the covered zone ß) at the viewing angles φ, φ′ where uneven luminance needs to be prevented. FIGS. 8 to 10 give examples of the solid portions in different shapes. FIG. 8 is a schematic sectional view showing yet another example of the backlight unit 12 according to First Embodiment. FIG. 9 is a schematic sectional view showing another example of the backlight unit 12 according to Second Embodiment. FIG. 10 is a schematic sectional view showing yet another example of the backlight unit 12 according to Second Embodiment.

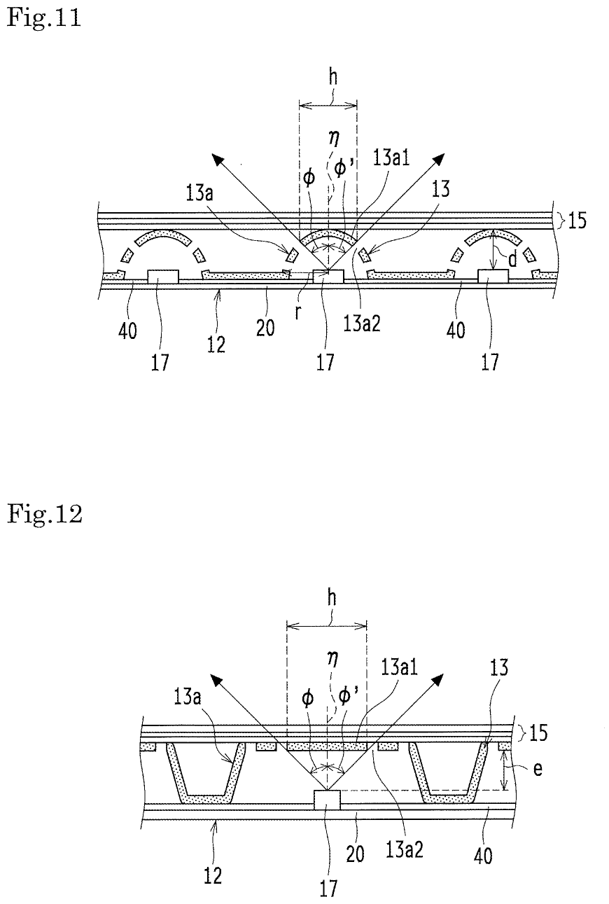

FIG. 11 is an explanatory drawing for giving more specific numerical description of the example shown in FIG. 7. For example, in FIG. 11, d represents the distance between the LEDs 17 and the optical member group 15, and r represents the outer radius of the semi-spherical reflector 13. The emission point of each LED 17 is at the center of a virtual sphere of the semi-spherical reflector 13. In this illustrated case, the distance d is equal to the radius r. Accordingly, in the reflector pattern 13a for shielding the range at the viewing angle φ of 45° or less, the width h of the light reflection part 13a1 is calculated as 2×d×sin φ. Specifically, when d is 5.0 mm, the width h of the light reflection part 13a1 in the reflector pattern 13a for shielding the range at the viewing angle φ of 45° or less is 2×5×sin 45°≠7 mm.

FIG. 12 is an explanatory drawing for giving more specific numerical description of the example shown in FIG. 9. In the reflector 13 shown in FIG. 12, e represents the spatial distance between the LEDs 17 and the reflector 13. In the reflector pattern 13a for shielding the range at the viewing angle φ of 45° or less, the width h of the light reflection part 13a1 is calculated as 2×e×tan φ. Specifically, when e is 5.0 mm, the width h of the light reflection part 13a1 in the reflector pattern 13a for shielding the range at the viewing angle φ of 45° or less is 2×5×tan 45°=10 mm.

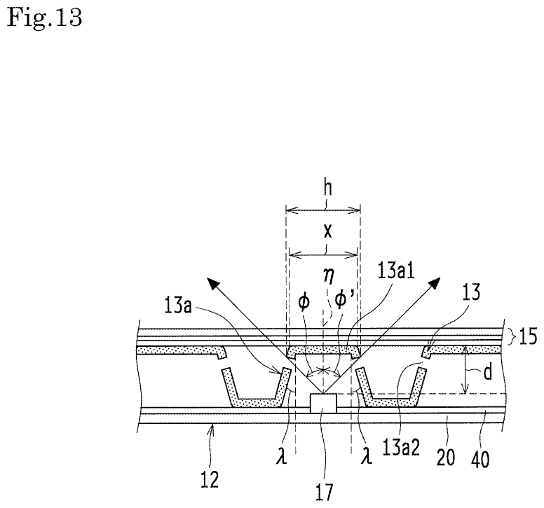

FIG. 13 is an explanatory drawing for giving more specific numerical description of the example shown in FIG. 10. In the reflector 13 shown in FIG. 13, d represents the distance between the LEDs 17 and the optical member group 15, and x represents the width of the flat portion of the light reflection part 13a1, opposed to the LED 17, in the reflector pattern 13a. The inclined portion of the reflector 13 is inclined at an angle λ=15° to the vertical. In the reflector pattern 13a for shielding the range at the viewing angle φ of 45° or less, the width h of the light reflection part 13a1 is calculated as x+2×[d—(x/2)×(1/tan φ)]×[tan λ/(1+tan λ/tan φ)]. Specifically, when d is 5.0 mm and x is 8 mm, the width h of the light reflection part 13a1 in the reflector pattern 13a for shielding the range at the viewing angle of 45° or less is 8+2×[5−(8/2)×(1/tan 45°)]×[tan 15°/(1+tan 15°/tan 45°)]≠8.4 mm.

### Third Embodiment

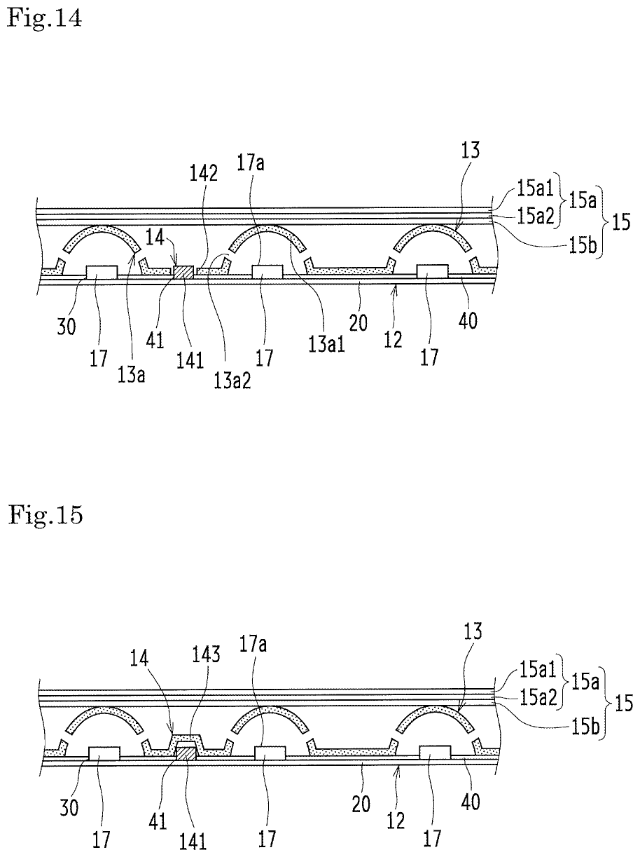

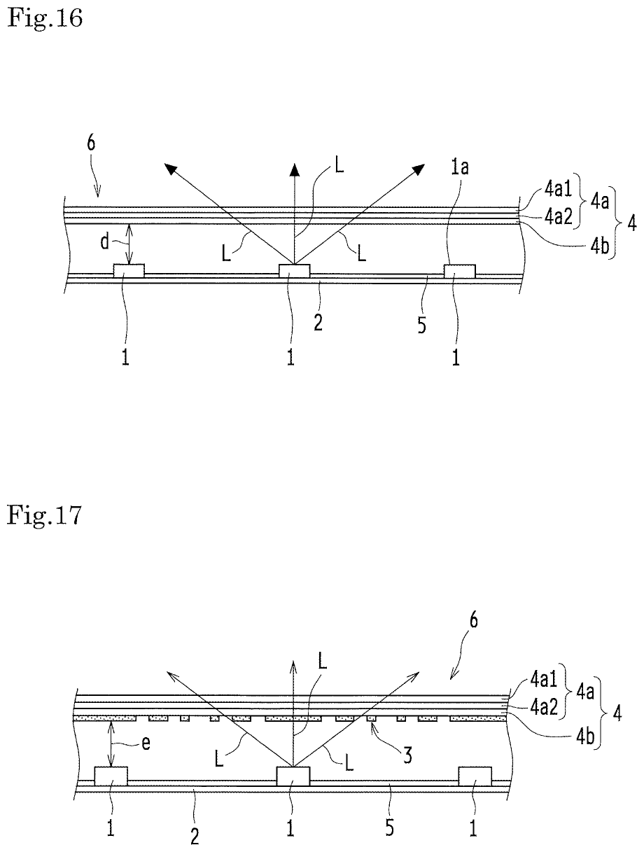

FIG. 14 is a partial schematic sectional view of the backlight unit 12 according to Third Embodiment.

The backlight unit 12 according to Third Embodiment is substantially identical to the backlight unit 12 according to First Embodiment, except for the presence of an example of a positioning unit 14.

To be specific, the backlight units 12 according to First and Third Embodiments have the same basic structure but are different in the following respect. Third Embodiment utilizes a structure for fixing the position of the reflector 13 in the planar direction of the LED board 20, which effectively prevents misalignment of the reflector 13 in the planar direction of the LED board 20.

The backlight unit 12 in the present embodiment is equipped with at least one positioning unit 14 for positioning the reflector 13 on the LED board 20.

The positioning unit 14 includes a protrusion 141 that is directly or indirectly fixed on the LED board 20. The reflector 13 is engaged with the protrusion 141. The protrusion 141 can restrict, in a simple manner, displacement of the reflector 13 in the planar direction of the LED board 20.

In this example, the reflector 13 has an aperture 142 (a through hole) to be engaged with the protrusion 141. The aperture 142 and the protrusion 141 constitute the positioning unit 14. This configuration can restrict, in a reliable manner, displacement of the reflector 13 in the planar direction of the LED board 20.

The protrusion 141 is positioned away from the LEDs 17 on the LED board 20. The shape of the protrusion 141 is not particularly limited, but is preferably as low as possible but high enough to be caught by the aperture 142 in the reflector 13. If the protrusion 141 is too high, the protrusion 141 interferes optically and makes the part around the protrusion 141 darker. To give a preferable example, the protrusion 141 is not lower than 0.5 mm and not higher than 2 mm. As exemplified in FIG. 14, the protrusion 141 may be provided on the LED board 20 and may project through an aperture 41 (a through hole) formed in the reflection sheet 40. Alternatively, the protrusion 141 may be provided on the reflection sheet 40.

If a suitable protruding object (e.g., an electric component such as a resistive element) is present on the LED board 20, the existing component can be utilized as the protrusion 141 instead of an additional protrusion. In this case, an additional dedicated component for the protrusion 141 is unnecessary, which leads to a simpler structure and cost reduction.

Specifically, the aperture 41 is formed in the reflection sheet 40 laid on the LED board 20 of the reflector 13, at a position corresponding to the protrusion 141 so as to accommodate the protrusion 141. The reflector 13 is disposed such that the protrusion 141 fits in the aperture 142 in the reflector 13. This arrangement can fix the reflector 13 in the planar direction of the LED board 20, and can effectively prevent misalignment of the reflector 13 in the planar direction of the LED board 20. The combination of the protrusion 141 and the aperture 142 is provided at one position, or preferably at least two positions, in the backlight unit 12.

In the above description, the positioning unit 14 according to Third Embodiment is applied to the configuration of First Embodiment, but is also applicable to the configuration of Second Embodiment.

### Fourth Embodiment

FIG. 15 is a partial schematic sectional view of the backlight unit 12 according to Fourth Embodiment.

The backlight unit 12 according to Fourth Embodiment is substantially identical to the backlight unit 12 according to First Embodiment, except for the presence of another example of the positioning unit 14.

To be specific, the backlight units 12 according to Third and Fourth Embodiments have the same basic structure but are different in following respect. In Fourth Embodiment, the protrusion 141 is engaged with the reflector 13 by means of a recess 143 (an indent) instead of the aperture 142 (a through hole).

The reflector 13 has a recess 143 to be engaged with the protrusion 141. The recess 143 and the protrusion 141 constitute the positioning unit 14. This positioning unit 14 can restrict displacement of the reflector 13 in the planar direction of the LED board 20 by the protrusion 141, while uneven luminance is suppressed.

In Third Embodiment, the positioning unit 14 is composed of the aperture 142 (a through hole). However, the backlight unit 12 of Third Embodiment may suffer from uneven luminance or a decrease in luminance if the optical reflectance of the protrusion 141 is smaller than that of the reflector 13 or if the optical reflectance of the protrusion 141 is not so small but the area of the protrusion 141 is large. In particular, if the protrusion 141 is a protruding object mounted on the LED board 20, the protruding object may possibly have a very low optical reflectance (e.g., a black object).

In Fourth Embodiment, the protrusion 141 is engaged with the reflector 13 not by the aperture 142 (a through hole) as described in Third Embodiment, but by a recess 143 (an indent) as shown in FIG. 15. The protrusion 141 is fitted in the recess 143 (an indented portion of the reflector 13). Since the protrusion 141 is completely covered with the reflector 13, this configuration can effectively prevent uneven luminance or a decrease in luminance.

In the above description, the positioning unit 14 according to Fourth Embodiment is applied to the configuration of First Embodiment, but is also applicable to the configuration of Second Embodiment.

The present invention can be embodied and practiced in other different forms without being limited to the above-described embodiments. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced in the scope of the present invention.

What is claimed is:

1. A lighting device comprising a substrate on which a plurality of light emitting elements are arranged side by side, and a reflector configured to diffusely reflect light emitted by the plurality of light emitting elements,
wherein the reflector comprises a predetermined reflector pattern including a light reflection part and a light transmission part,
wherein the reflector pattern is formed in the reflector such that the light reflection part overlaps the light emitting elements in front view, where each of the light emitting elements is focused on a center thereof and viewed in front of itself from one side of the substrate on which the light emitting elements are mounted, and
wherein the reflector is contoured three-dimensionally to include solid portions for covering the light emitting elements one by one in the front view.

2. The lighting device according to claim 1,
further comprising an optical member group provided on one side of the reflector that is not a substrate-facing side of the reflector,
wherein the reflector serves also as a support member for holding up the optical member group.

3. The lighting device according to claim 1,
wherein each of the solid portions of the reflector has a semi-spherical or semi-elliptical shape.

4. The lighting device according to claim 1,
wherein each of the solid portions of the reflector has a cone-like or frustum-like shape.

5. The lighting device according to claim 1,
wherein each of the solid portions of the reflector has a peripheral end that is an end closer to the substrate, and
wherein the light transmission part comprises a plurality of light transmission parts formed circumferentially and entirely along the peripheral end of each solid portion.

6. The lighting device according to claim 1,
further comprising a positioning unit configured to position the reflector on the substrate.

7. The lighting device according to claim 6,
wherein the positioning unit comprises a protrusion that is directly or indirectly fixed on the substrate, and
wherein the reflector is engaged with the protrusion.

8. The lighting device according to claim 7,
wherein the reflector has an aperture to be engaged with the protrusion.

9. The lighting device according to claim 7,
wherein the reflector has a recess to be engaged with the protrusion.

10. A display device comprising the lighting device according to claim 1.
